(19) United States
(12) Patent Application Publication
(10) Pub. No.: US 2025/0190038 A1
(43) Pub. Date: Jun. 12, 2025

(54) SYSTEMS AND METHODS FOR USING SENSED TEMPERATURE TO OPTIMIZE THERMAL BALANCE AMONG VOLTAGE REGULATOR PHASE BANKS IN POWER DELIVERY

(71) Applicant: Dell Products L.P., Round Rock, TX (US)

(72) Inventors: Guangyong ZHU, Austin, TX (US); Ralph H. JOHNSON, Round Rock, TX (US); Shiguo LUO, Austin, TX (US); Feng-Yu WU, Taipei City (TW)

(73) Assignee: Dell Products L.P., Round Rock, TX (US)

(21) Appl. No.: 18/534,876

(22) Filed: Dec. 11, 2023

(51) Int. Cl. G06F 1/26; H02M 3/04

(52) U.S. Cl. CPC G06F 1/26; H02M 3/04

(57) ABSTRACT

An information handling system may include one or more information handling resources and a power system comprising a plurality of voltage regulator phases each configured to generate an output voltage at its output from an input voltage, the plurality of voltage regulator phases distributed among a plurality of voltage regulator banks comprising at least a first voltage regulator bank and a second voltage regulator bank. The information handling system may also include a power controller configured to monitor a temperature imbalance between the first voltage regulator bank and the second voltage regulator bank and control electrical currents delivered by the plurality of voltage regulator phases as a function of the temperature imbalance in order to minimize the temperature imbalance.

### TECHNICAL FIELD

The present disclosure relates in general to information handling systems, and more particularly to systems and methods for using sensed temperatures associated with voltage regulator phases to optimize a thermal balance among voltage regulator phase banks in a power delivery system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may include a voltage regulator to provide a constant voltage level and a current to power the system. For example, a voltage regulator may receive an input voltage and produce an output current at a predetermined output voltage required by a load, i.e., the circuit element(s) for which it is providing power. Many voltage regulators may be capable of operating in multiple phases, wherein a phase for a voltage regulator may typically refer to combining a driver and a power stage to form one phase. Thus, a multi-phase voltage regulator may include multiple instances of such combinations.

To meet performance and power requirements of a power delivery architecture to an information handling system component (e.g., a processor, graphics processing unit, etc.), phases of a multi-phase voltage regulator may be split into a plurality of banks, each bank having one or more phases and each bank delivering electrical energy to a different portion of the component. For example, a processor may receive electrical energy for its “north” side from a “north” power regulator bank and may receive electrical energy for its “south” side from a “south” power regulator bank.

Such a distributed power delivery architecture may present challenges for a voltage regulator. For example, thermal imbalances may exist between the different voltage regulator banks due to differences in system ambient temperature, airflow conditions, and/or other thermal conditions between the voltage regulator banks. Thermal imbalance between different voltage regulator banks may be a concern as such imbalance may lead to a negative impact on performance of the component being powered from the different voltage regulator banks and/or lead to cooling system fan speeds operating at higher speeds in order to reduce temperatures.

### SUMMARY

In accordance with the teachings of the present disclosure, the disadvantages and problems associated with existing approaches to thermal control in a distributed voltage regulator system may be reduced or eliminated.

In accordance with embodiments of the present disclosure, an information handling system may include one or more information handling resources and a power system comprising a plurality of voltage regulator phases each configured to generate an output voltage at its output from an input voltage, the plurality of voltage regulator phases distributed among a plurality of voltage regulator banks comprising at least a first voltage regulator bank and a second voltage regulator bank. The information handling system may also include a power controller configured to monitor a temperature imbalance between the first voltage regulator bank and the second voltage regulator bank and control electrical currents delivered by the plurality of voltage regulator phases as a function of the temperature imbalance in order to minimize the temperature imbalance.

In accordance with these and other embodiments of the present disclosure, a method may be provided for a power system comprising a plurality of voltage regulator phases each configured to generate an output voltage at its output from an input voltage, the plurality of voltage regulator phases distributed among a plurality of voltage regulator banks comprising at least a first voltage regulator bank and a second voltage regulator bank. The method may include monitoring a temperature imbalance between the first voltage regulator bank and the second voltage regulator bank and controlling electrical currents delivered by the plurality of voltage regulator phases as a function of the temperature imbalance in order to minimize the temperature imbalance.

In accordance with these and other embodiments of the present disclosure, a power system may include a plurality of voltage regulator phases each configured to generate an output voltage at its output from an input voltage, the plurality of voltage regulator phases distributed among a plurality of voltage regulator banks comprising at least a first voltage regulator bank and a second voltage regulator bank. The power system may also include a power controller configured to monitor a temperature imbalance between the first voltage regulator bank and the second voltage regulator bank and control electrical currents delivered by the plurality of voltage regulator phases as a function of the temperature imbalance in order to minimize the temperature imbalance.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure; and

FIG. 2 illustrates a block diagram of functional blocks of a power controller, in accordance with embodiments of the present disclosure.

### DETAILED DESCRIPTION

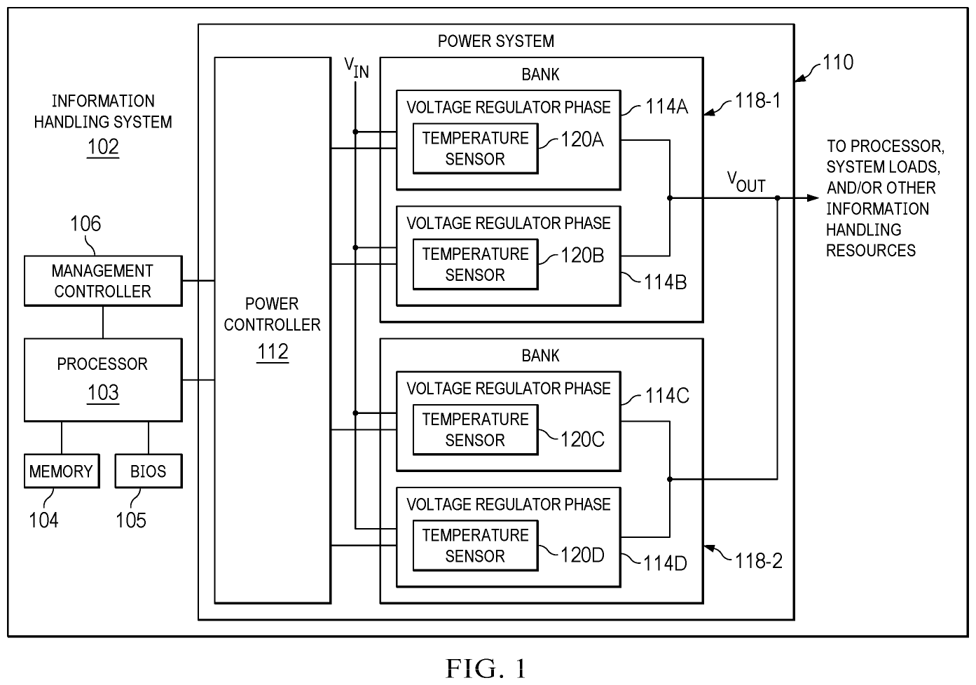

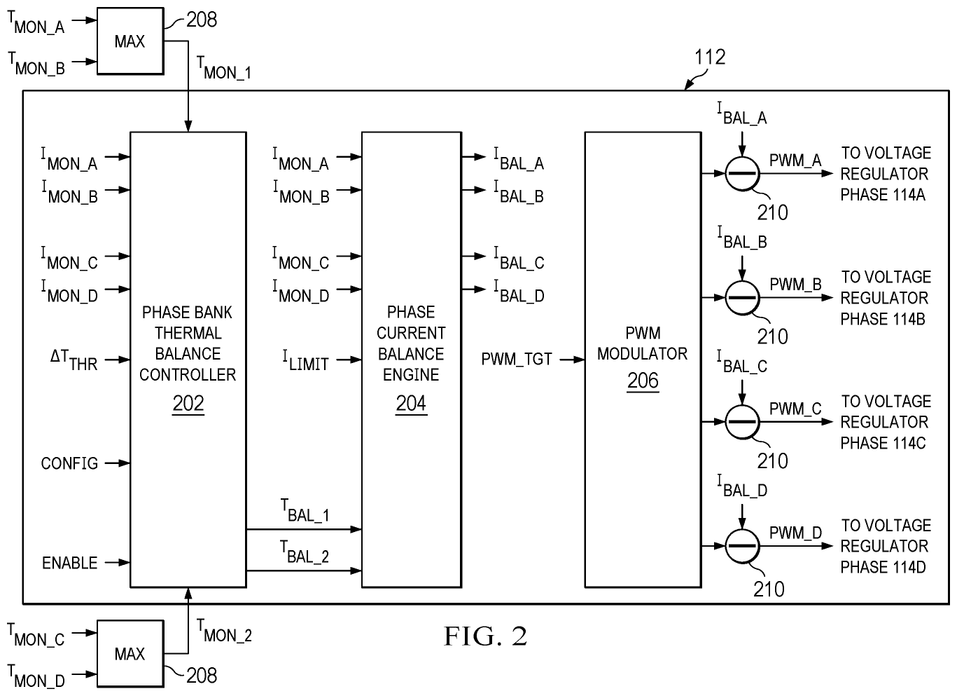

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal data assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, power supplies, air movers (e.g., fans and blowers) and/or any other components and/or elements of an information handling system.

FIG. 1 illustrates a block diagram of an example information handling system 102. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a basic input/output system (BIOS) 105 communicatively coupled to processor 103, a management controller 106 communicatively coupled to processor 103, and a power system 110 for supplying power to processor 103, system loads of information handling system 102, and/or one or more information handling resources of information handling system 102.

Processor 103 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may comprise any system, device, or apparatus operable to retain program instructions or data for a period of time. Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102.

Management controller 106 may be configured to provide out-of-band management facilities for management of information handling system 102. Such management may be made by management controller 106 even if a host system of information handling system 102 is powered off or powered to a standby state. Management controller 106 may include a processor, memory, an out-of-band network interface separate from and physically isolated from an in-band network interface of information handling system 102, and/or other embedded information handling resources. In certain embodiments, management controller 106 may include or may be an integral part of a baseboard management controller (BMC) or a remote access controller (e.g., a Dell Remote Access Controller or Integrated Dell Remote Access Controller). In other embodiments, management controller 106 may include or may be an integral part of a chassis management controller (CMC).

Power system 110 may include a power controller 112, and a plurality of voltage regulator phases 114 (e.g., voltage regulator phases 114A-114D) distributed across a plurality of voltage regulator banks 118 (e.g., voltage regulator banks 118-1, 118-2), wherein each voltage regulator bank 118 may be located in a substantially different location within information handling system 102. In addition, power system 110 may include a plurality of temperature sensors 120 (e.g., temperature sensors 120A-120D), wherein each temperature sensor 120 may be configured to sense a respective temperature proximate to an associated voltage regulator phase 114 or voltage regulator bank 118, and generate an electrical or electronic signal indicative of such sensed temperature. Temperature sensors 120 may comprise thermometers, thermistors, or any other suitable temperature sensing device. As shown in FIG. 1, in some embodiments, each temperature sensor 120 may be integral to a respective voltage regulator phase 114.

Power controller 112 may include any system, device, or apparatus configured to control the output of power system 110, including the control of switches internal to voltage regulator phases 114 to generate desired electrical current to be delivered to information handling resources of information handling system 102.

Each voltage regulator phase 114 may include any system, device, or apparatus configured to supply a portion of the total current output of power system 110. In embodiments in which power system 110 is a multi-phase voltage regulator, a voltage regulator phase 114 may comprise a phase of the voltage regulator. As shown in FIG. 1, a voltage regulator phase 114 may be controlled (e.g., switched) so as to receive an input voltage VIN and convert such input voltage VIN to an output voltage Vour. An example of a voltage regulator phase 114 is shown and described below in regards to FIG. 2.

In addition to processor 103, memory 104, BIOS 105, management controller 106, power system 110, voltage regulator phases 114, voltage regulator banks 118, and temperature sensors 120, information handling system 102 may include one or more other information handling resources. For example, in some embodiments, power system 110 may include greater or fewer voltage regulator phases 114 than that depicted in FIG. 1. As another example, in some embodiments, power system 110 may include greater or fewer voltage regulator banks 118 than that depicted in FIG. 1. As a further example, a voltage regulator bank 118 may include greater or fewer voltage regulator phases 114 than that depicted in FIG. 1.

FIG. 2 illustrates a block diagram of functional blocks of power controller 112, in accordance with embodiments of the present disclosure. As shown in FIG. 2, power controller 112 may include a phase bank thermal controller 202, a phase current balance engine 204, and a pulse-width modulation (PWM) modulator 206.

Further, although not shown in FIG. 1 for purposes of clarity and exposition, power system 110 may include maximum detectors 208. A first maximum detector 208 may output the maximum of a sensed temperature T_{MON_A} (e.g., from temperature sensor 120A) and a sensed temperature T_{MON_B} (e.g., from temperature sensor 120B) to generate a maximum bank temperature T_{MON_1} (e.g., associated with voltage regulator bank 118-1) which may be received by a first temperature sense pin of power controller 112. Similarly, a second maximum detector 208 may output the maximum of a sensed temperature T_{MON_C} (e.g., from temperature sensor 120C) and a sensed temperature T_{MON_D} (e.g., from temperature sensor 120D) to generate a maximum bank temperature T_{MON_2} (e.g., associated with voltage regulator bank 118-2) which may be received by a second temperature sense pin of power controller 112.

As shown in FIG. 2, phase bank thermal balance controller 202 may receive a number of signals including without limitation maximum bank temperature T_{MON_1}, maximum bank temperature T_{MON_2}, sensed currents I_{MON_A}, I_{MON_B}, I_{MON_C}, and I_{MON_D}, a temperature adjustment threshold ΔT_{THR}, a configuration indicator CONFIG, and an enable signal ENABLE.

Sensed currents I_{MON_A}, I_{MON_B}, I_{MON_C}, and I_{MON_D} may each be generated by current sensing circuitry (not shown in the figures) and may each indicate a current output by a respective voltage regulator phase 114 (e.g., sensed currents I_{MON_A}, I_{MON_B}, I_{MON_C}, and I_{MON_D} may correspond to currents output by voltage regulator phases 114A, 114B, 114C, and 114D, respectively).

Temperature adjustment threshold ΔT_{THR} may comprise a fixed or configurable value indicating a minimum difference in temperatures between power regulator banks 118 for triggering a modification of currents output by voltage regulator phases 114.

Configuration indicator CONFIG may comprise a signal that indicates an arrangement of voltage regulator phases 114 and voltage regulator banks 118. While FIG. 1 depicts a particular configuration in which power system 110 has two voltage regulator banks 118 each having two voltage regulator phases 114 and FIG. 2 depicts a power controller 112 configured to control the configuration shown in FIG. 1, a power system 110 may have any suitable arrangement of voltage regulator banks 118 and voltage regulator phases 114, and thermal balance among voltage regulator banks 118 may be affected by the particular arrangement being used. Accordingly, configuration indicator CONFIG may indicate the particular arrangement to phase bank thermal balance controller 202 such that phase bank thermal balance controller 202 may take the arrangement of voltage regulator banks 118 and voltage regulator phases 114 into account when controlling thermal balance.

Enable signal ENABLE may comprise a signal indicating whether or not power controller 112 should implement thermal balancing. In some embodiments, enable signal ENABLE may be user configurable, while in other embodiments, enable signal ENABLE may be automatically set based on one or more conditions present in information handling system 102.

Based on the various signals it receives, and in particular maximum bank temperature T_{MON_1} and maximum bank temperature T_{MON_2}, phase bank thermal balance controller 202 may generate one or more thermal adjustment signals indicative of desired thermal adjustments to be made to the temperatures of voltage regulator banks 118. For example, phase bank thermal balance controller 202 may generate a thermal adjustment signal T_{BAL_1} indicative of a desired thermal adjustment to voltage regulator bank 118-1 and a thermal adjustment signal T_{BAL_2} indicative of a desired thermal adjustment to voltage regulator bank 118-2.

As shown in FIG. 2, phase current balance engine 204 may receive sensed currents I_{MON_A}, I_{MON_B}, I_{MON_C}, and I_{MON_D}, thermal adjustment signals T_{BAL_1} and T_{BAL_2}, and current limit I_{LIMIT}. Current limit I_{LIMIT} may be fixed or configurable and may indicate a maximum magnitude of current to be generated by a voltage regulator phase 114.

In operation, phase current balance engine 204 may, based on the various signals it receives, and in particular thermal adjustment signals T_{BAL_1} and T_{BAL_2}, generate current adjustment signals indicative of current adjustments to be made to the currents generated by voltage regulator phases 114 in order to provide the thermal adjustments indicated by thermal adjustment signals T_{BAL_1} and T_{BAL_2}. For example, phase current balance engine 204 may generate a current adjustment signal I_{BAL_A} indicative of a current adjustment to applied to voltage regulator phase 114A, a current adjustment signal I_{BAL_B} indicative of a current adjustment to applied to voltage regulator phase 114B, a current adjustment signal I_{BAL_C} indicative of a current adjustment to applied to voltage regulator phase 114C, and a current adjustment signal I_{BAL_D} indicative of a current adjustment to applied to voltage regulator phase 114D.

PWM modulator 206 may comprise any suitable system, device, or apparatus configured to generate PWM signals for driving voltage regulator phases 114. As shown in FIG. 2, PWM modulator 206 may receive a PWM target signal PWM_TGT indicative of a target pulse width or duty cycle for voltage regulator phases 114 in the absence of temperature balancing, and generate “raw” PWM signals for driving voltage regulator phases 114.

Power controller 112 may also include a plurality of signal combiners 210, each signal combiner 210 configured to sum a raw PWM signal generated by PWM modulator 206 with a respective current adjustment signal in order to generate a modified PWM signal for driving a respective voltage regulator phase 114. For example, a first signal combiner 210 may sum a raw PWM signal with current adjustment signal I_{BAL_A} to generate a modified PWM signal PWM_A for driving voltage regulator phase 114A, a second signal combiner 210 may sum a raw PWM signal with current adjustment signal I_{BAL_B} to generate a modified PWM signal PWM_B for driving voltage regulator phase 114B, a third signal combiner 210 may sum a raw PWM signal with current adjustment signal I_{BAL_C} to generate a modified PWM signal PWM_C for driving voltage regulator phase 114C, and a fourth signal combiner 210 may sum a raw PWM signal with current adjustment signal I_{BAL_D} to generate a modified PWM signal PWM_D for driving voltage regulator phase 114D.

To illustrate the temperature balancing functionality of power controller 112, consider an instance in which a temperature sensor 120A or 120B of voltage regulator bank 118-1 senses a temperature significantly higher than temperatures sensed by temperature sensor 120C and 120D of voltage regulator bank 118-2. In such instance, maximum bank temperature T_{MON_1} may be significantly higher than maximum bank temperature T_{MON_2}, signaling to phase bank thermal balance controller 202 a thermal imbalance between voltage regulator bank 118-1 and voltage regulator bank 118-2. Accordingly, thermal balance controller 202 may generate thermal adjustment signal T_{BAL_1} to indicate a desired decrease in temperature proximate to voltage regulator bank 118-1 and/or generate thermal adjustment signal T_{BAL_2} to indicate a desired increase in temperature proximate to voltage regulator bank 118-2.

As a result, phase current balance engine 204 may, in response to thermal adjustment signal T_{BAL_1}, decrease current adjustment signal I_{BAL_A} and/or current adjustment signal I_{BAL_B}, Which may in turn decrease modified PWM signal PWM_A and/or modified PWM signal PWM_B, which may lead to a decrease in temperature proximate to voltage regulator bank 118-1. In addition or alternatively, phase current balance engine 204 may, in response to thermal adjustment signal T_{BAL_2}, increase current adjustment signal I_{BAL_C} and/or current adjustment signal I_{BAL_D}, which may in turn increase modified PWM signal PWM_C and/or modified PWM signal PWM_D, which may lead to an increase in temperature proximate to voltage regulator bank 118-2.

In some embodiments, a percentage of current steered between voltage regulator banks 118 may be a linear function of the difference in temperature of voltage regulator banks 118. In other embodiments, modifications to current sharing may be based on a predefined lookup table to nonlinear function.

In these and other embodiments, as mentioned above, phase bank thermal balance controller 202 may be configured to initiate changes in currents driven by voltage regulator phases 114 only if the temperature difference exceeds temperature adjustment threshold ΔT_{THR}. Further, phase current balance engine 204 may limit any increases or decreases in currents driven by voltage regulator phases 114 in accordance with current limit I_{LIMIT}.

Thus, power controller 112 is operable to monitor a real-time temperature difference among voltage regulator banks 118 and dynamically modify current sharing among voltage regulator banks 118 to bring temperatures of voltage regulator banks 118 back into balance.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
one or more information handling resources; and
a power system comprising:
a plurality of voltage regulator phases each configured to generate an output voltage at its output from an input voltage, the plurality of voltage regulator phases distributed among a plurality of voltage regulator banks comprising at least a first voltage regulator bank and a second voltage regulator bank; and
a power controller configured to:
monitor a temperature imbalance between the first voltage regulator bank and the second voltage regulator bank; and
control electrical currents delivered by the plurality of voltage regulator phases as a function of the temperature imbalance in order to minimize the temperature imbalance.

2. The information handling system of claim 1, wherein one or more voltage regulator phases of the first voltage regulator bank deliver electrical current to a first location of the information handling system and one or more voltage regulator phases of the second voltage regulator bank deliver electrical current to a second location of the information handling system.

3. The information handling system of claim 1, further comprising:
at least one first temperature sensor configured to sense a first temperature proximate to the first voltage regulator bank; and
at least one second temperature sensor configured to sense a second temperature proximate to the second voltage regulator bank;
such that the temperature imbalance is equivalent to a difference between the first temperature and the second temperature.

4. The information handling system of claim 3, wherein the power controller is configured to cause a decrease in electrical current delivered by one or more voltage regulators within the first voltage regulator bank in response to the first temperature exceeding the second temperature.

5. The information handling system of claim 3, wherein the power controller is configured to cause an increase in electrical current delivered by one or more voltage regulators within the first voltage regulator bank in response to the second temperature exceeding the first temperature.

6. A method comprising, in a power system comprising a plurality of voltage regulator phases each configured to generate an output voltage at its output from an input voltage, the plurality of voltage regulator phases distributed among a plurality of voltage regulator banks comprising at least a first voltage regulator bank and a second voltage regulator bank:
monitoring a temperature imbalance between the first voltage regulator bank and the second voltage regulator bank; and
controlling electrical currents delivered by the plurality of voltage regulator phases as a function of the temperature imbalance in order to minimize the temperature imbalance.

7. The method of claim 6, wherein one or more voltage regulator phases of the first voltage regulator bank deliver electrical current to a first location of the information handling system and one or more voltage regulator phases of the second voltage regulator bank deliver electrical current to a second location of the information handling system.

8. The method of claim 6, further comprising:
sensing a first temperature proximate to the first voltage regulator bank; and
sensing a second temperature proximate to the second voltage regulator bank;
such that the temperature imbalance is equivalent to a difference between the first temperature and the second temperature.

9. The method of claim 8, further comprising causing a decrease in electrical current delivered by one or more voltage regulators within the first voltage regulator bank in response to the first temperature exceeding the second temperature.

10. The method of claim 8, further comprising causing an increase in electrical current delivered by one or more voltage regulators within the first voltage regulator bank in response to the second temperature exceeding the first temperature.

11. A power system comprising:
a plurality of voltage regulator phases each configured to generate an output voltage at its output from an input voltage, the plurality of voltage regulator phases distributed among a plurality of voltage regulator banks comprising at least a first voltage regulator bank and a second voltage regulator bank; and
a power controller configured to:
monitor a temperature imbalance between the first voltage regulator bank and the second voltage regulator bank; and
control electrical currents delivered by the plurality of voltage regulator phases as a function of the temperature imbalance in order to minimize the temperature imbalance.

12. The power system of claim 11, wherein one or more voltage regulator phases of the first voltage regulator bank deliver electrical current to a first location of the information handling system and one or more voltage regulator phases of the second voltage regulator bank deliver electrical current to a second location of the information handling system.

13. The power system of claim 11, further comprising:
at least one first temperature sensor configured to sense a first temperature proximate to the first voltage regulator bank; and
at least one second temperature sensor configured to sense a second temperature proximate to the second voltage regulator bank;
such that the temperature imbalance is equivalent to a difference between the first temperature and the second temperature.

14. The power system of claim 13, wherein the power controller is configured to cause a decrease in electrical current delivered by one or more voltage regulators within the first voltage regulator bank in response to the first temperature exceeding the second temperature.

15. The power system of claim 13, wherein the power controller is configured to cause an increase in electrical current delivered by one or more voltage regulators within the first voltage regulator bank in response to the second temperature exceeding the first temperature.
